(19) United States
(12) Patent Application Publication
(10) Pub. No.: US 2023/0418900 A1
(43) Pub. Date: Dec. 28, 2023

(54) MULTI-VIEW OUTLIER DETECTION FOR POTENTIAL RELATIONSHIP CAPTURE WITH PAIRED COMPARISON AVOIDANCE

(71) Applicant: NANJING UNIVERSITY OF AERONAUTICS AND ASTRONAUTICS, Nanjing (CN)

(72) Inventors: Songcan CHEN, Nanjing (CN); Yingyu ZHONG, Nanjing (CN)

(73) Assignee: NANJING UNIVERSITY OF AERONAUTICS AND ASTRONAUTICS, Nanjing (CN)

(21) Appl. No.: 17/846,149

(22) Filed: Jun. 22, 2022

(51) Int. Cl. G06F 17/16; G06F 17/11

(52) U.S. Cl. CPC G06F 17/16; G06F 17/11

(57) ABSTRACT

A multi-view outlier detection algorithm based on the tensor representation is provided. Specifically, the multi-view data are firstly transformed into a set of tensors, and then its low-rank representation is learned. Finally, an outlier function is designed in the case of tensor representation to realize detection.

### BACKGROUND OF THE INVENTION

### Field of the Invention

The present invention relates to the field of machine learning, and more particularly to a multi-view outlier detection method based on tensor representation, which is used for solving problems of outlier detection in a multi-view scene.

### Description of the Related Art

Outlier detection, also known as anomaly detection, is a data analysis technique for identifying abnormal samples in a data set. In recent years, a great number of outlier detection methods have been developed. However, these outlier detection algorithms are designed for single-view data, which are not suitable for multi-view outlier detection scenes.

Actually, much data usually come from different domains or different feature extractors, and each set of corresponding features can be regarded as a specific view, thus forming multi-view data. Since noise interference with feature extraction, outliers often exist in the multi-view data, which may affect subsequent tasks. Therefore, researchers began to pay attention to how to detect the outliers from the multi-view data.

Tensor, when representing the multi-view data, can be used to fully capture possible relationships among multiple views of data, and to avoid pairwise comparison between views as well. As far as we know, the multi-view outlier detection method based on tensor representation has not been studied yet. Most methods in the conventional art adopt cross-view pairwise constraints to obtain new feature representations, and define outlier scoring metrics according to these features, which have not fully used interactive information between views, and have led to higher complexity when dealing with three or more views. In order to make up for this deficiency, the present disclosure proposes a new multi-view outlier detection algorithm based on the tensor representation, so as to fully capture the possible relationships among multiple views of the data, and meanwhile, to avoid the paired comparison between the views

### BRIEF SUMMARY OF THE INVENTION

The present disclosure proposes a multi-view outlier detection method based on tensor representation to solve problems of the multi-view outlier detection. The above method in the present disclosure is applicable to a variety of scenarios, for example, a detection of abnormal users (such as water army, and follower transaction) of microblog or post bar. The technical solutions of the present disclosure are as follows:

A multi-view outlier detection method based on tensor representation is provided, including following steps:
S1: transforming original multi-view samples into a form of the tensor representation to form a set of multi-view tensors; and expanding each tensor into a vector to obtain a transformed sample matrix;
S2: constructing an objective function for low-rank representation learning for the sample matrix, and calculating an optimal representation coefficient matrix and error matrix which minimize a value of the objective function; and
S3: calculating outlier scores of all samples according to the representation coefficient matrix and the error matrix obtained in S2, to output outlier labels of all samples.

Further, according to the multi-view outlier detection method based on the tensor representation, S1 specifically includes:
S101: predefining a set D={X¹, X², . . . , X^{M}} with M view data to represent user behaviors, wherein X^{v}ϵR^{d}^{ᵥ}^{×N} represents N samples in the v^{th} view, and dᵥ is a feature dimension; and each xᵢ^{v} is normalized according to xᵢ^{v}=xᵢ^{v}/∥xᵢ^{v}∥; where, the set with the view data forms a data set of different views by constructing the user behaviors, social relations and publishing contents;
S102: constructing a corresponding multi-view tensor according to Xᵢ=xᵢ¹∘xᵢ²∘ . . . ∘xᵢ^{v}∘ . . . ∘xᵢ^{M}ϵR^{d}^{₁}^{×d}^{₂}^{× . . . ×d}^{_{M}} for each multi-view sample, to obtain the set of the multi-view tensors I={Xᵢ}ᵢ₌₁^{N}, wherein Xᵢ represents the multi-view tensor of the i^{th} instance; where, the multi-view tensors I={Xᵢ=xᵢ¹∘xᵢ²∘ . . . ∘xᵢ^{M}ϵR^{d}^{₁}^{×d}^{₂}^{. . . ×d}^{_{M}}}ᵢ₌₁^{N} may be constructed depending on the above data set D to characterize the user behaviors of each user; and
S103: expanding each multi-view tensor X into a vector form tϵR^{d}^{₁}^{d}^{₂}^{. . . d}^{_{M}}^{×1}, to transform the set of the multi-view tensors I into a sample matrix T=[t₁ t₂ . . . t_{N}]ϵR^{d}^{₁}^{d}^{₂}^{. . . d}^{_{M}}^{×N}.

The sample matrix T=[t₁ t₂ . . . t_{N}]ϵR^{d}^{₁}^{d}^{₂}^{. . . d}^{_{M}}^{×N} of the user behaviors is obtained. The user behaviors of the abnormal users are quite different from those of normal users, so there is low-rank mutual representation. Then, a mathematical model is established to solve.

Further, according to the multi-view outlier detection method based on the tensor representation, S2 specifically includes:
S201: constructing the objective function for low-rank representation learning for the sample matrix T:

min_{Z,E}∥Z∥_{*}+α∥E∥_{2,1}s.t T=TZ+E (1)
wherein Z=[z₁ z₂ . . . z_{N}]ϵR^{N×N} is the representation coefficient matrix; and
each zᵢϵR^{N×1} is a representation coefficient of a vector;
EϵR^{d}^{₁}^{d}^{₂}^{. . . d}^{_{M}}^{×N} is the error matrix, M represents a trace-norm, and ∥⋅∥_{*} represents an l_{2,1} norm; and
S202, solving the objective function for low-rank representation learning (l) of the sample matrix T by solving following Augmented Lagrange multiplier problem:

min_{Z,E,J}∥J∥_{*}+α∥E∥_{2,1}+tr[Y₁^{T}(T−TZ−E)]+tr[Y₂^{T}(Z−J)]+μ(∥T−TZ−E∥_{F}²+∥Z−J∥_{F}²)/2 (2)
wherein variables in the problem (2) are solved by an imprecise ALM algorithm.

Further, according to the multi-view outlier detection method based on the tensor representation, S3 specifically includes:
S301: calculating the outlier score for each sample according to o(i)=−∥Z(:,i)∥_{E}²+β∥E(:,i)∥_{E}², wherein o(i) represents an outlier of the i^{th} instance, and β>0 is a trade-off parameter; and
S302: calculating the outlier label L according to a predefined threshold γ, after the outlier scores of the instances are calculated:

if o(i)>γ,L(i)=1; otherwise, L(i)=0.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a flow chart showing a process for multi-view outlier detection based on tensor representation; and

FIG. 2 is a flow chart showing a process for solving a representation coefficient matrix and an error matrix with imprecise ALM.

### DETAILED DESCRIPTION OF THE INVENTION

Embodiments of the invention provide for multi-view outlier detection based upon tensor representation. In an embodiment of the invention, first and second data structures are defined in memory of a host computer. Thereafter, original multi-view samples are transformed by a processor of the host computer into the first data structure as a tensor representation to form a set of multi-view tensors stored in the first data structure. Thereafter, the processor vectorizes each tensor in the first data structure into the second data structure so as to produce a transformed sample matrix. The processor then constructs an objective function for low-rank representation learning for the sample matrix, and calculates an optimal representation coefficient matrix and error matrix, so as to minimize a value of the objective function. The processor calculates outlier scores of all samples according to the representation coefficient matrix and the error matrix obtained in the vectorization, in order to output outlier labels of all samples. The processor then creates a file for storage in fixed storage of the host computer, the file including a set of outlier scores of all of the samples in the vectorized form of the data structure, the detected outliers capturing possible relationships among multiple views of the tensor representation while avoiding a paired comparison between the views.

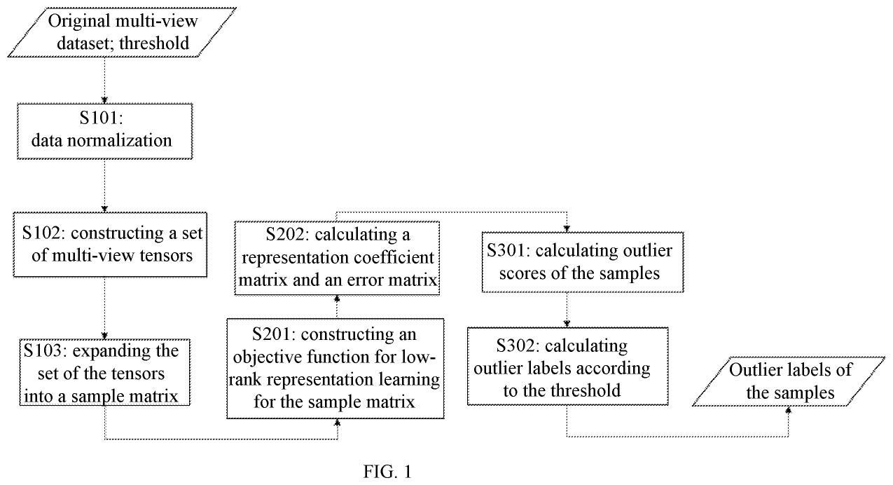

In more particular illustration, referring to FIG. 1, a flow chart is shown illustrating a multi-view outlier detection method based on tensor representation which includes steps S1-S3.
S1: Original multi-view samples are transformed into a form of the tensor representation to form a set of multi-view tensors; and each tensor is expanded into a vector to obtain a transformed sample matrix.
S2: An objective function for low-rank representation learning is constructed for the sample matrix, and an optimal representation coefficient matrix and error matrix are calculated, which minimize a value of the objective function.
S3: Outlier scores of all samples are calculated according to the representation coefficient matrix and the error matrix obtained in Step S2, to output outlier labels of all samples.

Further, the multi-view outlier detection method based on the tensor representation is provided, wherein Step S1 specifically includes S101-S103.
S101: Set representation D={X¹, X², . . . , X^{M}} with M view data is predefined, wherein X^{v}ϵR^{d}^{ᵥ}^{×N} represents N samples in the v^{th} view, and dᵥ is a feature dimension. Each xᵢ^{v} is normalized according to xᵢ^{v}=xᵢ^{v}/∥xᵢ^{v}∥.

S102: A corresponding multi-view tensor is constructed according to Xᵢ=xᵢ¹ ∘xᵢ² ∘ . . . ∘xᵢ^{M}ϵR^{d}^{₁}^{×d}^{₂}^{× . . . ×d}^{_{M}} for each multi-view sample, to obtain the set of the multi-view tensors I={Xᵢ}ᵢ₌₁^{N}, wherein Xᵢ represents the multi-view tensor of the i^{th} instance.

S103: Each multi-view tensor X is expanded into a vector form tϵR^{d}^{₁}^{d}^{₂}^{. . . d}^{_{M}}^{×1}, to transform the set of the multi-view tensors I into a sample matrix T=[t₁ t₂ . . . t_{N}]ϵR^{d}^{₁}^{d}^{₂}^{. . . d}^{_{M}}^{×N}.

Further, the multi-view outlier detection method based on the tensor representation is provided, wherein Step S2 specifically includes S201-S202.

S201: The objective function for low-rank representation learning is constructed for the sample matrix T:

min_{Z,E}∥Z∥_{*}+α∥E∥_{2,1}s.t T=TZ+E (2.1)
wherein Z=[z₁ z₂ . . . z_{N}]ϵR^{N×N} is a representation coefficient matrix, and each zᵢϵR^{N×1} is a representation coefficient of a vector.

EϵR^{d}^{₁}^{d}^{₂}^{. . . d}^{_{M}}^{×N} is an error matrix. ∥⋅∥_{*} represents a trace norm, and ∥⋅∥_{2,1} represents an l_{2,1} norm.

S202: The objective function for low-rank representation learning (2.1) of the sample matrix T mentioned above is solved by solving the following Augmented Lagrange multiplier problem:

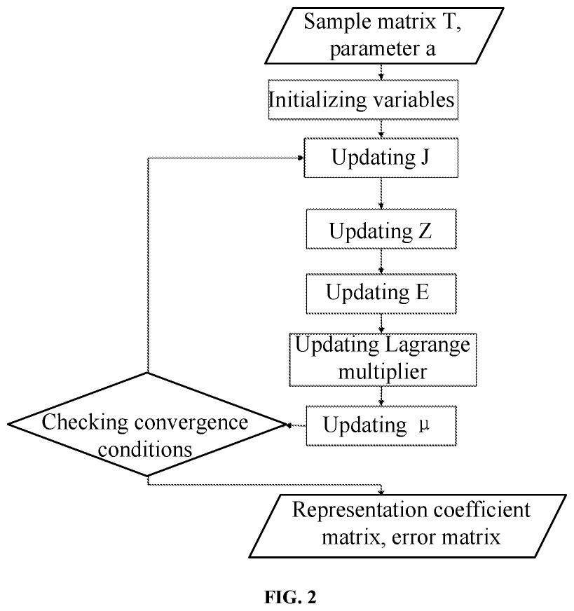

min_{Z,E,J}∥J∥_{*}+α∥E∥_{2,1}+tr[Y₁^{T}(T−TZ−E)]+tr[Y₂^{T}(Z−J)]+μ(∥T−TZ−E∥_{F}²∥+∥Z−J∥_{F}²)/2 (2.2)
where variables in problem (2.2) can be solved by an imprecise ALM algorithm. Solution process is shown in FIG. 2, which is described in detail as below:

Variables are initialized: Z=J=0, E=0, Y₁=0, Y₂=0, μ=10⁻⁶, μₘₐₓ=10¹⁰, ρ=1.1, ε=10⁻⁸.

J is updated: only items related to J are retained to obtain:

J=argmin∥J∥_{*}/μ+∥J−(Z+Y₂/μ)∥_{F}²/2 (2.2.1)

A singular value threshold (SVT) algorithm may be used to get the optimal solution of this problem.

Z is updated: only items related to Z are retained to obtain:

Z=argmin tr[Y₁^{T}(T−TZ−E)]+tr[Y₂^{T}(Z−J)]+μ(∥T−TZ−E∥_{F}²+∥Z−J∥_{F}²)/2 (2.2.2)

A derivative of (2.2.2) is set to 0 to solve (2.2.2), then an optimal solution of Z may be obtained:

Z=(I+T^{T}T)⁻¹(T^{T}T−T^{T}E+J+(T^{T}Y₁−Y₂)/μ) (2.2.3)

E is updated: only items related to E are retained to obtain:

E=argmin α∥E∥_{2,1}/μ+∥E−(T−TZ+Y₁/μ)∥_{F}²/2 (2.2.4)

Solution of formula (2.2.4) has been studied and discussed. Specifically, when Ω=T−TZ+Y₁/μ, the form of solution E* is as follows:

$${E}^{*} ( : , i ) = \{ \begin{matrix}‖ Ω ( : , i ) ‖ - α ) Ω ( : , i ) / ‖ Ω ( : , i ) ‖ , \\ if α < ‖ Ω ( : , i ) ‖ \\ 0 , otherwise\end{matrix} \qquad ( 2.2 \text{.5} )$$

The Lagrange multiplier is updated:

Y₁=Y₁+μ(T−TZ−E) (2.2.6)

Y₂=Y₂+μ(Z−J) (2.2.7)

μ is updated:

μ=min(ρμ,μₘₐₓ) (2.2.7)

Convergence conditions are checked: ∥T−TZ−E∥_{∞}<ε and ∥Z−J∥_{∞}<ε.

Further, according to the multi-view outlier detection method based on the tensor representation, Step S3 specifically includes S301-S302.

S301: The outlier score is calculated for each sample according to o(i)=−∥Z(:,i)∥_{E}²+β∥E(:,i)∥_{E}², wherein o(i) represents an outlier of the i^{th} instance. β>0 is a trade-off parameter.

S302: After the outlier scores of the instances are calculated, the outlier label L is calculated according to a predefined threshold γ:

if o(i)>γ,L(i)=1; otherwise, L(i)=0.

The foregoing process can be used to detect abnormal objects in scenarios with multiple data sources known as multi-view. Unlike convention object detection, as described herein the behavior information of different views of the object is fused firstly by tensor representation, and then an anomaly score of the object is calculated by an algorithm. Based on a predefined threshold, it is determined whether the object is an abnormal object (whether the abnormal score is higher than the threshold). This is conducive to retain original behavior information of different views of the object, and fully mine the high-order interaction information between views, which is conducive to the detection of the abnormal object.

Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A multi-view outlier detection method, comprising:
defining first and second data structures in memory of a host computer;
transforming original multi-view samples into the first data structure as a tensor representation to form a set of multi-view tensors stored in the first data structure;
vectorizing in the second data structure, each tensor in the first data structure, the vectorization producing a transformed sample matrix;
constructing an objective function for low-rank representation learning for the sample matrix, and calculating an optimal representation coefficient matrix and error matrix, which minimize a value of the objective function;
calculating outlier scores of all samples according to the representation coefficient matrix and the error matrix obtained in the vectorization, so as to output outlier labels of all samples; and,
creating a file for storage in fixed storage of the host computer, the file including a set of outlier scores of all of the samples in the vectorized form of the data structure, the detected outliers capturing possible relationships among multiple views of the tensor representation while avoiding a paired comparison between the views.

2. The multi-view outlier detection method according to claim 1, wherein the transforming step comprises:
predefining set representation D={X\hat{ }1, X\hat{ }2, . . . , X\hat{ }M} with M view data, wherein X\hat{ }vϵR\hat{ }(d_v×N), represents N samples in a vth view, and dv is a feature dimension; and each x_i\hat{ }v is normalized according to x_i\hat{ }v=x_i\hat{ }v/|x_i\hat{ }v|;
constructing a corresponding multi-view tensor according to X_i=x_i\hat{ }1∘x_i\hat{ }2∘ . . . ∘x_i\hat{ }v∘ . . . ∘x_i\hat{ }MϵR\hat{ }(d_1×d_2× . . . ×d_M) for each multi-view sample, to obtain the set of the multi-view tensors I={X_i}_(i=1)\hat{ }N, wherein Xi represents the multi-view tensor of an ith instance; and
expanding each multi-view tensor X into a vector form tϵR^{d}^{₁}^{d}^{₂}^{. . . d}^{_{M}}^{×1}, to transform the set of the multi-view tensors I into a sample matrix T=[t₁ t₂ . . . t_{N}]ϵR^{d}^{₁}^{d}^{₂}^{. . . d}^{_{M}}^{×N}.

3. The multi-view outlier detection method according to claim 1, wherein the constructing comprises:
constructing the objective function for low-rank representation learning for the sample matrix T:
min_{Z,E}∥Z∥_{*}+α∥E∥_{2,1} s.t T=TZ+E (1)
wherein Z=[z₁ z₂ . . . z_{N}]ϵR^{N×N} is the representation coefficient matrix; each zᵢϵR^{N×1} is a representation coefficient of a vector, EϵR^{d}^{₁}^{d}^{₂}^{. . . d}^{_{M}}^{×N} is the error matrix, ∥⋅∥_{*} represents a trace norm, and ∥⋅∥_{2,1} represents an l_{2,1} norm; and
solving the objective function for low-rank representation learning (1) of the sample matrix T by solving following Augmented Lagrange multiplier problem:
min_{Z,E,J}∥J∥_{*}+α∥E∥_{2,1}+tr[Y₁^{T}(T−TZ−E)]+tr[Y₂^{T}(Z−J)]+μ(∥T−TZ−E∥_{F}²+∥Z−J∥_{F}²)/2 (2)
wherein variables in the problem (2) are solved by an imprecise ALM algorithm.

4. The multi-view outlier detection method according to claim 1, wherein calculating comprises:
calculating the outlier score for each sample according to [symbol] o(i)=−|Z(:,i)| [symbol] _F\hat{ }2+β|E(:,i)|_F\hat{ }2, wherein o(i) represents an outlier of an ith instance, and β>0 is a trade-off parameter; and
calculating the outlier label L according to a predefined threshold γ, after the outlier scores of the instances are calculated:
if o(i)>γ,L(i)=1; otherwise, L(i)=0.
